(19) United States
(12) Patent Application Publication
(10) Pub. No.: US 2006/0041707 A1
(43) Pub. Date: Feb. 23, 2006

(54) Computer systems with multiple CPU configuration

(75) Inventor: Chien-Hsin Chou, Taipei City (TW)

Correspondence Address: BIRCH STEWART KOLASCH & BIRCH, PO BOX 747, FALLS CHURCH, VA, 22040-0747, US

(73) Assignee: ASROCK INCORPORATION

(21) Appl. No.: 11/183,825

(22) Filed: Jul. 19, 2005

(30) Foreign Application Priority Data
Aug. 18, 2004 (TW) 93125039

(51) Int. Cl. G06F 13/36; G06F 13/00

(52) U.S. Cl. 710/316; 710/306

(57) ABSTRACT

A method and device providing multiple CPU configuration of a computer system are disclosed. A motherboard supporting the device is also provided. When a module with a first CPU is not connected to the motherboard via an expansion connector, a second CPU is connected with the system logic unit, and the expansion connector is disconnected from the system logic unit. When the module is connected to the expansion connector, the second CPU is disconnected from the system logic unit, and the system logic unit is electrically connected with the expansion connector.

### BACKGROUND

The invention relates to a computer system with multiple CPU configurations, and more particularly, to methods and apparatuses providing multiple CPU configurations to a computer system.

FIG. 1A is a block diagram of a conventional computer motherboard. The motherboard comprises a CPU area 11 and a system core logic area 12. The CPU area 11 comprises a CPU 111 and a CPU control circuit 112 controlling the power supply and thermal solution for the CPU. The CPU area 11 connects to the system core logic area 12 via bus 121.

The system core logic area 12 comprises a system chipset 120, a system memory 132 coupled thereto via system memory bus 122, a system input/output controller 133 coupled thereto via system input/output bus 123 and a system control circuit 134 coupled thereto via system control bus 124.

Single or multiple system memory buses 122 on the motherboard connect to one or more memory devices such as a SDRAM bus and a DDR SDRAM bus. A Dual Channel system memory bus utilizes two independent memory controllers for improved system performance.

The system input/output controller 133 controls interfaces with external devices. One or more system input/output buses each connect to one or more system input/output devices and may be a PCI bus and/or an ISA bus. Input/output connectors 135 connected to different interface buses 125 respectively connect to external devices/cables thereby.

System control circuit 134 contains circuits controlling the power and thermal solutions for the computer system.

FIG. 1B is another block diagram of a computer motherboard. The motherboard comprises a CPU area 11 and a system core logic area 12. The difference between this system and that shown in FIG. 1A is system memory 113 connecting to the CPU 111 instead of the system core logic chipset 120, allowing the CPU to directly access system memory for high speed computing without accessing system logic chipset 120. All other devices access system memory through system logic chipset 120, which directs the requests to CPU 111.

Conventional motherboards comprise core logic chipsets and CPU configurations that cannot be changed. Installation of a CPU not compatible with the initial CPU socket requires replacement of motherboard, and possibly related devices, representing considerable inconvenience and cost.

### SUMMARY

A method and device providing multiple CPU configuration of a computer system are disclosed. A motherboard supporting the device is also provided. When a module with a first CPU is not connected to the motherboard via an expansion connector, a second CPU is connected with the system logic unit, and the expansion connector is disconnected from the system logic unit. When the module is connected to the expansion connector, the second CPU is disconnected from the system logic unit, and the system logic unit is electrically connected with the expansion connector.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### DESCRIPTION OF THE DRAWINGS

The accompanying drawings, incorporated in and constitute a part of this specification, illustrate embodiments of the invention and, together with the description, serve to explain the features, advantages, and principles of the invention.

FIGS. 1A and 1B are block diagrams of conventional computer systems.

FIG. 2 is a block diagram of a motherboard according to an embodiment of the invention.

FIG. 3 is a block diagram of a module applied with the motherboard of FIG. 2.

FIG. 4 is a block diagram of a motherboard according to another embodiment of the invention.

FIG. 5 is a block diagram of a module applied with the motherboard of FIG. 4.

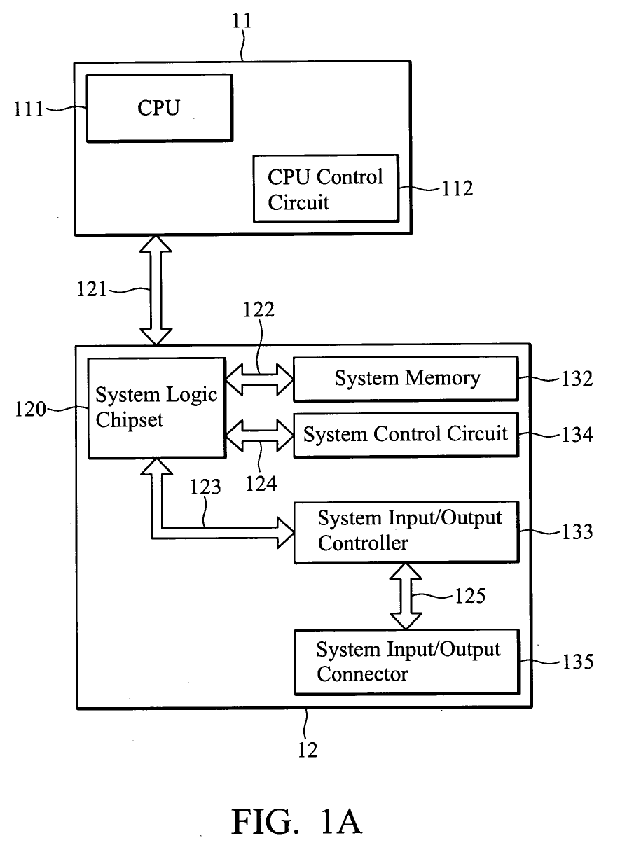

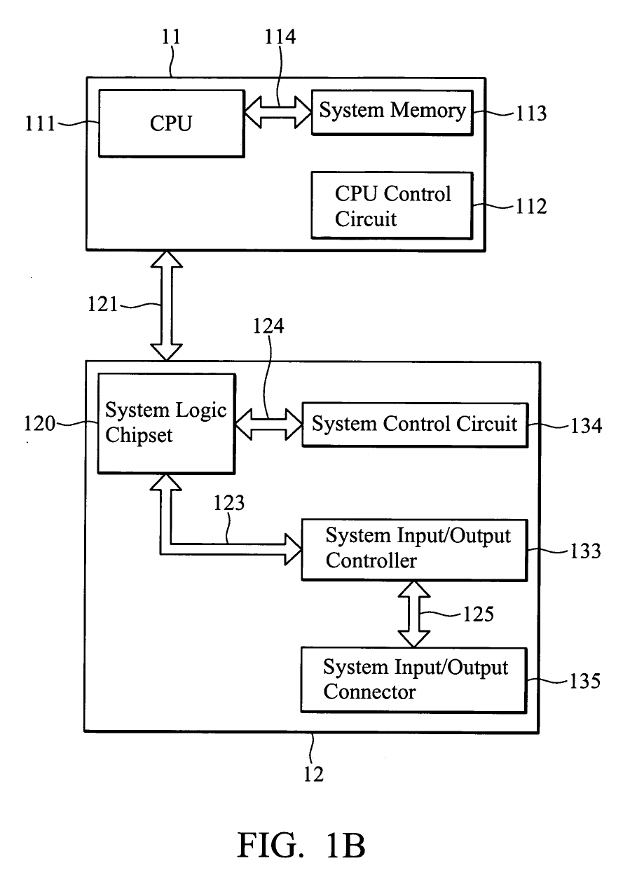

### DETAILED DESCRIPTION

The invention is adaptive to change the CPU configuration in a computer system. Various core logic chipsets support more than one type of CPU. Bus signals between the system core logic chipset and an initial CPU, switched to connect with another upgraded CPU, allow an existing motherboard to accommodate different types of CPUs. A module is provided to carry the second CPU for upgrading. An expansion connector on the motherboard connects the module. When the module connects to the expansion connector, the core logic chipset is disconnected from the initial CPU interface, and electrically connected to the expansion connector, to communicate with the upgraded CPU carried by the module. A bus switching device selectively switches the connection to the core logic chipset between the initial CPU interface and the expansion connector.

The system memory may connect to the CPU rather than the core logic chipset. The module must comprise system memory devices if the upgraded CPU on the module controls the memory interface.

The bus switching device can be a set of jumpers set to connect the system core logic chipset to the initial CPU or to the expansion connector, or a bus switching IC chip receiving a control signal generated in the motherboard, which sets the signal to a first state to control the bus switching IC to connect the core logic chipset with the initial CPU when the expansion connector is empty, and a second state to control the bus switching IC to connect the core logic chipset with the expansion connector when the expansion connector connects to the module. The bus switching device disconnects the unused device and its related bus routing from the active bus, improving the signal integrity by preventing the loading and signal reflection caused by the unused device and the is bus routing.

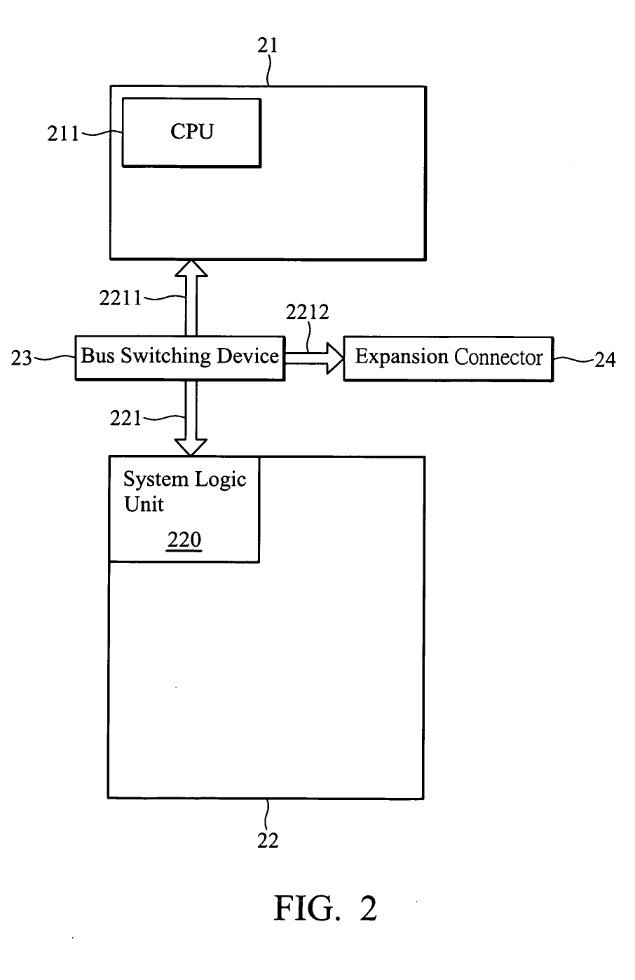

FIG. 2 is a block diagram of a motherboard according to an embodiment of the invention. The motherboard comprises a CPU area 21, a system logic area 22, a bus switching device 23 and an expansion connector 24.

CPU area 21 comprises a CPU 211, assembled initial or connecting to the motherboard through an initial CPU socket. The CPU area 21 further comprises other devices connect directly to the second CPU 211 but the system logic area 22. For example, if CPU 211 connects directly to a system memory, the CPU area 21 comprises system memory (not shown). The CPU area 21 further comprises control circuits (not shown) controlling the power supply and thermal solutions of the CPU area 21.

System logic area 22 connects to bus switching device 23 via bus 221. The bus switching device 23 connects to CPU area 21 via bus 2211 and the expansion connector 24 via the bus 2212. The bus switching device 23 electrically connects the signals of the bus 221 to the signals of bus 2211 if the expansion connector 24 is not connected to any device. The system logic area 22 connects to the second CPU area 21 and forms a complete system structure that boots and computes normally.

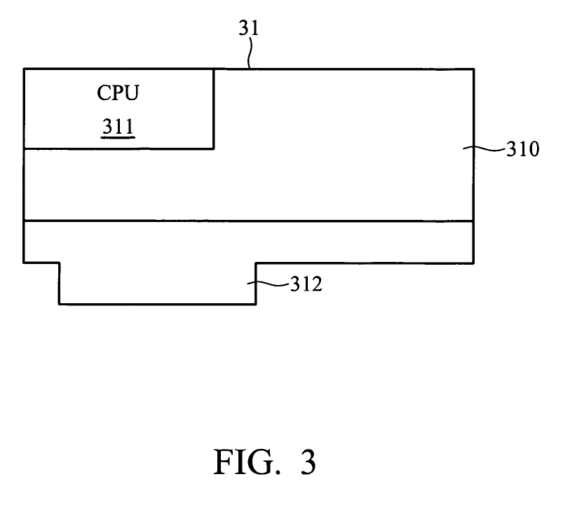

FIG. 3 shows a block diagram of a module applicable with the motherboard of FIG. 2. The module 31 comprises a CPU area 310 and a signal connector 312 connecting with the expansion connector 24. CPU 311 can be assembled initial or connect to the CPU area 310 through an initial CPU socket. The module 31 further comprises other devices which connect directly to the first CPU 311. For example, if the first CPU 311 connects directly to the system memory, the module 31 comprises system memory (not shown).

The bus switching device 23 electrically connects the signals of the bus 221 with the signals of the bus 2212 if the expansion connector 24 is connected to the module 31. The system logic area 22 connects to the first CPU area 310 and forms a complete system structure that boots and computes normally.

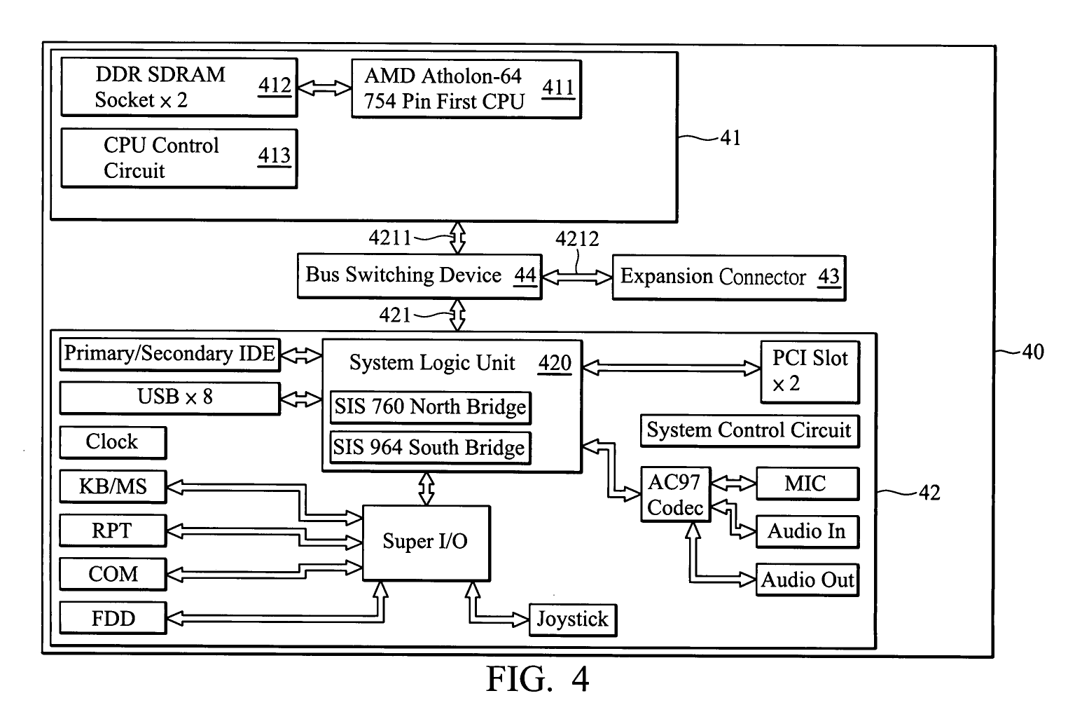

FIG. 4 is a block diagram of a motherboard according to another embodiment of the invention. The motherboard comprises a CPU area 41, a system logic area 42, a bus switching device 44 and an expansion connector 43.

The CPU area 41 comprises a CPU 411 (AMD Athelon-64 754 pin), assembled initial or connecting to the motherboard through an initial CPU socket.

Because the AMD Athelon-64 754 pin CPU comprises a single channel DDR SDRAM interface, the CPU area 41 further comprises two DDR SDRAM sockets 412 to connect system memory devices. The CPU area 41 further comprises CPU control circuits 413 controlling the power supply and thermal solutions for the second CPU area 41.

The system logic area 42 comprises the system core logic unit 420 (SIS 760 Northbridge and SIS964 Southbridge system core logic chipset). The system logic area 42 further comprises all other devices not directly connected to the CPU area 41.

The system logic area 42 connects to the bus switching device 43 via the bus 421. The bus switching device 44 connects to the CPU area 41 via the bus 4211 and to the expansion connector 43 via the bus 4212. The bus switching device 44 electrically connects the signals of the bus 421 with the signals of the bus 4211 if the expansion connector 43 is not connected to any device. The system logic area 42 connects to the CPU area 41 and forms a complete system structure that boots and computes normally.

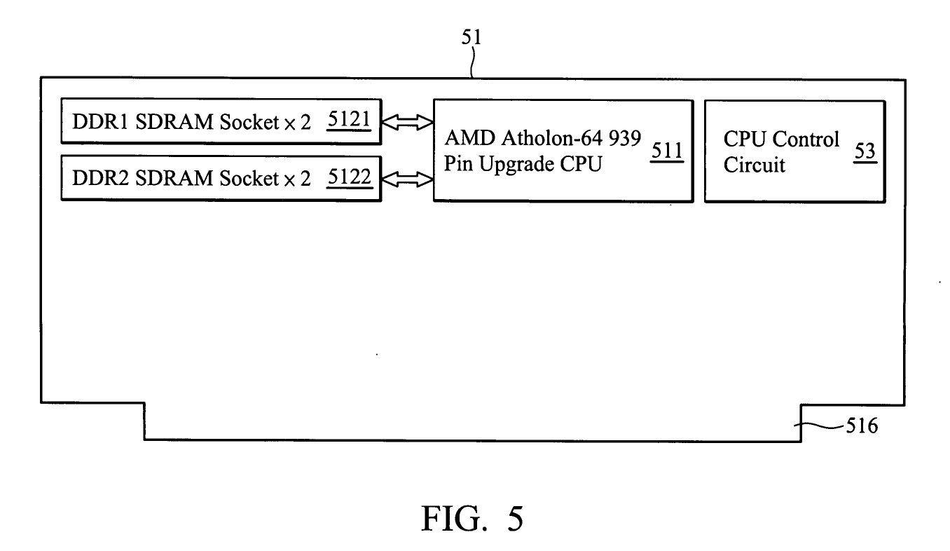

FIG. 5 is a block diagram of a module applicable with the motherboard of t FIG. 4. The module 51 comprises a CPU 511 (AMD Athelon-64 939 pin CPU) and a signal connector 516 connecting with the expansion connector 43, assembled initial or connecting to the module through an initial CPU socket.

The module 51 further comprises other devices directly connected to the CPU but not the system logic area 42. Because the AMD Athelon-64 939 pin CPU comprises dual channel DDR SDRAM interfaces, the module 51 further comprises four DDR SDRAM sockets (5121, 5122) to connect system memory devices. The module 51 further comprises CPU control circuits 53 controlling power supply and thermal solutions of the module 51.

The bus switching device 44 electrically connects the signals of the bus 421 with the signals of the bus 4212 if the expansion connector 43 is connected to the module 51. The system logic area 42 connects to the module 51 and forms a complete system structure that could be boot up and compute normally.

The invention enables replacement of CPUs in a computer system, reducing cost and inconvenience.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method of providing multiple CPU configurations for a computer system; the method comprising:
providing a module comprising a first CPU;
providing a motherboard comprising a system logic unit, a second CPU and an expansion connector;
electrically connecting the second CPU with the system logic unit, and disconnecting the expansion connector from the system logic unit, when the module is not connected to the expansion connector; and
electrically disconnecting the second CPU from the system logic unit, and electrically connecting the system logic unit with the expansion connector when the module is connected to the expansion connector.

2. A motherboard accepting multiple CPU configurations by connecting to a module with a first CPU, comprising:
a second CPU;
a system logic unit;
an expansion connector for connection of the module; and
a bus switching device selectively coupled between the second CPU, the system logic unit and the expansion connector; wherein the bus switching device electrically connects the second CPU to the system logic unit when the module is not connected to the expansion connector and electrically connects the expansion connector to the system logic unit when the module is connected to the expansion connector.

3. The motherboard as claimed in claim 2 further comprising a second CPU socket for connection of the second CPU on the motherboard.

4. The motherboard as claimed in claim 2, wherein the bus switching device is a set of jumpers.

5. The motherboard as claimed in claim 2, wherein the bus switching device is a bus switching integrated circuit (IC) controlled by a switching signal generated in the motherboard.

6. The motherboard as claimed in claim 5, wherein the switching signal is in a first state if the module is not connected to the expansion connector and in a second state if the module is connected to the expansion connector; wherein the bus switching integrated circuit (IC) connects the system logic unit with the second CPU when the switching signal is in the first state and connects the system logic unit with the expansion connector when the switching signal is in the second state.

7. The motherboard as claimed in claim 2, wherein the first CPU is an AMD Athelon-64 939 pins series CPU.

8. The motherboard as claimed in claim 2, wherein the second CPU is an AMD Athelon-64 754 pins series CPU.

9. A computer system accepting multiple CPU configurations, comprising:
a module comprising an first CPU;
a motherboard comprising:
a second CPU;
a system logic unit;
an expansion connector for connection of the module; and
a bus switching device coupled between the second CPU, the system logic unit and the expansion connector; wherein the bus switching device electrically connects the second CPU to the system logic unit when the module is not connected to the expansion connector and electrically connects the expansion connector to the system core logic unit when the module is connected to the expansion connector.

10. The computer system as claimed in claim 9, wherein the motherboard further comprises a second CPU socket to connect the second CPU.

11. The computer system as claimed in claim 9, wherein the module further comprises a first CPU socket to connect the first CPU.

12. The computer system as claimed in claim 9, wherein the bus switching device is a set of jumpers.

13. The computer system as claimed in claim 9, wherein the bus switching device is a bus switching integrated circuit (IC) controlled by a switching signal generated in the motherboard.

14. The computer system as claimed in claim 13, wherein the switching signal is in a first state if the module is not connected to the expansion connector and in a second state if the module is connected to the expansion connector; wherein the bus switching integrated circuit (IC) connects the system logic unit with the second CPU when the switching signal is in the first state, and connects the system core logic unit with the expansion connector when the switching signal is in the second state.

15. The computer system as claimed in claim 9, wherein the first CPU is an AMD Athelon-64 939 pins series CPU.

16. The computer system as claimed in claim 9, wherein the second CPU is an AMD Athelon-64 754 pins series CPU.
